(19) United States
(12) Patent Application Publication
(10) Pub. No.: US 2006/0095622 A1
(43) Pub. Date: May 4, 2006

(54) System and method for improved memory performance in a mobile device

(75) Inventors: Stephan Rosner, Campbell, CA (US); Mark McClain, San Diego, CA (US); Eugen Gershon, San Jose, CA (US)

Correspondence Address: TOLER & LARSON & ABEL L.L.P., 5000 PLAZA ON THE LAKE STE 265, AUSTIN, TX, 78746, US

(73) Assignee: Spansion, LLC

(21) Appl. No.: 10/975,629

(22) Filed: Oct. 28, 2004

(51) Int. Cl. G06F 13/00

(52) U.S. Cl. 710/107

(57) ABSTRACT

A system and method are disclosed for improved memory performance in a mobile device. A mobile device incorporating teachings disclosed herein may include, for example, a central processing unit (CPU) residing on a first chip. The mobile device may also include a memory system residing on a second chip. The memory system may include, for example, a memory controller and at least one type of memory combined in a single multi-chip package. The multi-chip package may effectively internalize higher pin count interfaces interconnecting the memory controller and the at least one type of memory. With some implementations, a high frequency, low pin-count external bus may form at least a portion of a link communicatively coupling the multi-chip package and the CPU. In practice, the high frequency, low pin-count external bus may physically connect to a bus interface residing on the first chip. The bus interface may be communicatively coupled to the CPU via an internal CPU bus also located on the first chip. In operation, the bus interface may provide bus translation between the high frequency, low pin-count external bus, and the internal CPU bus.

### FIELD OF THE INVENTION

The present invention is generally related to memory systems, and more specifically to a system and method for improved memory performance in a mobile device.

### BACKGROUND

In recent years, mobile hand-held devices like cellular telephones, smartphones, and personal digital assistants (PDA's) have seen a marked increase in their capabilities. To help support these new capabilities, device designers have been asked to develop high performance memory systems that are low cost, consume little power, and take up little room.

Many end users now want mobile devices that support features like wireless voice and data communication, Internet browsing, text messaging, game playing, the downloading and playing of music, as well as digital-camera functionality and applications. Combining just a few of these applications into a single device often requires a relatively complex combination of a core processor, an application processor, a memory controller, and various types of memory.

In practice, a high pin-count memory controller typically manages access to the memory and resides on chip with the core processor, which may be complimented by an application processor. To improve memory performance, and potentially overall device performance, a designer may be asked to increase the access speed of a memory, which may not be possible based on device physics, or to widen the data bus, which may be limited by the bus width of the memory controller. In many circumstances, adding width to the memory controller bus entails increasing the pin count and driving overall memory related costs beyond an acceptable threshold.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for mobile device memory operation that incorporates teachings of the present disclosure;

FIG. 2 shows one embodiment of a mobile device that incorporates teachings of the present disclosure; and

FIG. 3 presents a block diagram of a dual core system for a wireless-enabled device having a memory subsystem that incorporates teachings of the present disclosure.

The use of the same reference symbols in different drawings indicates similar or identical items.

### DESCRIPTION

Embodiments discussed below focus on improving memory system performance in mobile devices. In preferred embodiments, memory performance is enhanced while reducing total memory cost. Though the following discussions focus on this implementation of the teachings, the teachings may be applied in other circumstances as well.

Although certain embodiments are described using specific examples, it will be apparent to those skilled in the art that the invention is not limited to these few examples. Accordingly, the present invention is not intended to be limited to the specific form set forth herein, but on the contrary, it is intended to cover such alternatives, modifications, and equivalents, as can be reasonably included within the spirit and scope of the disclosure.

From a high level, a mobile device incorporating teachings disclosed herein may have a central processing unit (CPU) included in a first package. The first package may be formed using several different types of packaging techniques and may include, for example, a system on a chip (SoC) and/or a special purpose modular subsystem. In some embodiments, the CPU may be one device or include a collection of devices such as an Advanced RISC Machines (ARM™) core and a Digital Signal Processing (DSP) core. The first package or SoC may also include an audio interface, a Radio Frequency (RF) interface, and peripheral interconnectivity mechanisms. The mobile device may also include a memory system residing in a second package. The memory system may include, for example, a memory controller and at least one type of memory combined in a single package, which may be included as part of a multi-package package. The memory type may be not, for example, NOR Flash, NAND Flash, SRAM, SDRAM, DDR, and/or some other appropriate memory type.

The single memory package may effectively internalize the high pin count data bus interconnecting the memory controller and at least one type of memory. Though much of this disclosure refers to memory controller in the singular form, the term memory controller may also describe a structure that encompasses more than one controller. For example, the memory controller in some of the below discussed embodiments may actually include both a volatile memory controller and a non-volatile memory controller. The two controllers may be discrete components and may be individually connected to a memory via point-to-point pin connections. In addition and in some implementations, a high frequency, low pin-count external bus may form at least a portion of a link communicatively coupling a memory package and a different package containing some or all of the CPU components. In practice, the high frequency, low pin-count external bus may physically connect to a bus interface residing on the CPU chip or package. The bus interface may be communicatively coupled to the CPU via an internal CPU bus similarly located. In operation, the bus interface may provide bus translations between the high frequency, low pin-count external bus, and the internal CPU bus.

In effect, the above-described mobile device design may provide a CPU/memory system interface that relies on a relatively low external pin count. In the above-described device, pint-to-pin interconnects and/or a wide data bus may facilitate communication between the memory controller and the actual memory may be implemented via internal interconnects included within the memory package. For example, a 64-bit wide data bus may be implemented within the memory package without incurring the corresponding rise in external pin count.

Keeping the external pin count low may help to keep manufacturing costs in check. Moreover, such a design may allow for better performance. Depending upon design concerns, a memory subsystem that incorporates wide banks with internalized pins may be able to facilitate higher memory bandwidth with minimum device cost. Moreover, pre-fetches may be performed using the above-described memory subsystem architecture, which may allow higher perceived performance. Memory subsystems may also become more scalable as a result of mixing and matching various memory types, densities, etc., and traffic shaping may become more feasible through the utilization of memory subsystem-based background copies—allowing mobile device designers to design for average, as opposed to peak bandwidth.

In one implementation, a high frequency, four-pin external bus may be operated at 200 MHz and may provide an operational bandwidth of approximately 100 MB/s. In addition, the use of low-voltage differential signaling (LVDS) across the low pin-count external bus may allow for clock rates in the GHz range. This may allow for sufficient bandwidth and latency headroom in complex multiplexing schemes like those associated with time division multiple access (TDMA) transmissions.

Other benefits may also be present in the above-described mobile device. For example, the memory architecture of the device may enjoy improved noise immunity, favorable electromagnetic interference (EMI) characteristics, and improved power efficiency. Moreover, collocating the memory controller and memories in a single package of a multi-package package (MPP) may provide some performance enhancements. Such an architecture may facilitate, for example, local copying inside the memory subsystem without loading the CPU bus, pre-fetching within the memory subsystem while utilizing locality in the address stream, and some pre-processing capabilities in various streaming data applications.

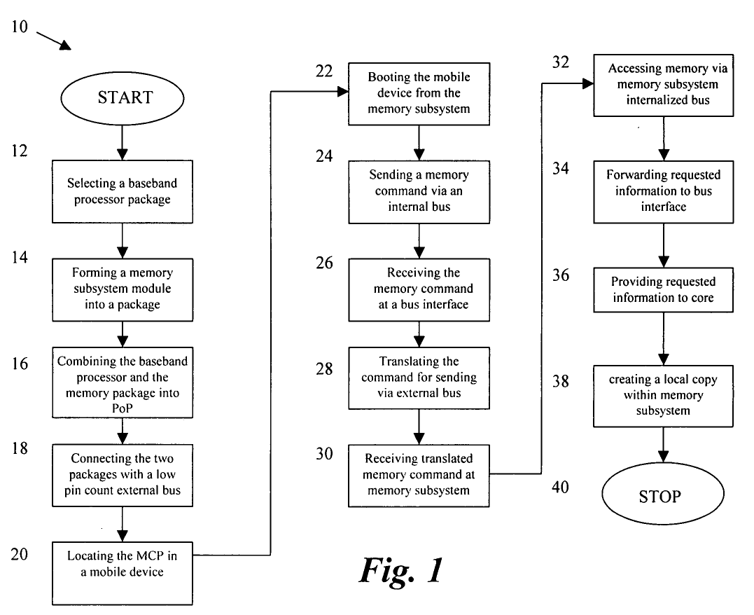

As mentioned above, FIG. 1 presents a flow diagram for a mobile device memory process 10 that incorporates teachings of the present disclosure. Process 10 may begin at step 12, which may be a design phase step. A device designer may select an appropriate baseband processor package for a given device application. If, for example, the device is intended for a multi-media smartphone application, the designer may need to ensure that the selected baseband processor package includes sufficient processing power. The baseband package may need a CPU that includes, for example, an ARM core, one or more DSP cores, and a special purpose application processor.

At step 14, the device designer may select a memory subsystem that compliments the selected processor package. The memory subsystem may include at least one memory controller and at least one type of memory. In practice, the memory subsystem may include several dies. One die may contain the logic that implements the memory controller, and the other dies may contain different types of memory. The subsystem could include, for example, Flash, SRAM, SDRAM, and/or other types of memory. The memory types may be selected based at least partially on the intended use of the device being designed. The selected memory types and the controller may be formed into a package that represents a modular memory subsystem.

At step 16, the selected baseband package and the selected memory package may be combined into a multi-package package (MPP), which may be configured, for example, as a Package on Package or stacked configuration. In some implementations, the MPP may be designed such that the memory package resides above the baseband package. The two packages may be at least partially interconnected to allow package-to-package communication by a low pin-count external bus. However interconnected, the MPP may be located within a mobile device at step 20.

At step 22, the mobile device may be booted from the memory package. In practice, performance critical information may be stored in a memory of the memory subsystem as opposed to be stored on package with the CPU. Steady state device operation may begin after boot up, and at step 24 a memory command may be communicated via an internal bus of the baseband package. At step 26, the memory command may be received by a bus interface, which may translate the command at step 28 for communication via an external bus.

At step 30, the memory subsystem may receive the translated command and access memory package at step 32 to effectuate the command. If, for example, the memory command was a read command, requested information may be forwarded to the bus interface at step 34. And, at step 36, the requested information may be provided to a core processor.

Process 10 may also allow for off-baseband package processing. For example, a local copy of information may be made on the memory package without baseband package involvement. At step 36, the memory package may create a Flash copy of information stored in SRAM, for example. Other off-baseband package processing may occur and/or process 10 may advance to step at step 40. The steps of process 10 may be amended, deleted, re-ordered, added to, looped, and/or otherwise modified without departing from the teachings of the present disclosure. In addition, the entity performing a given step may alter without departing from the teachings.

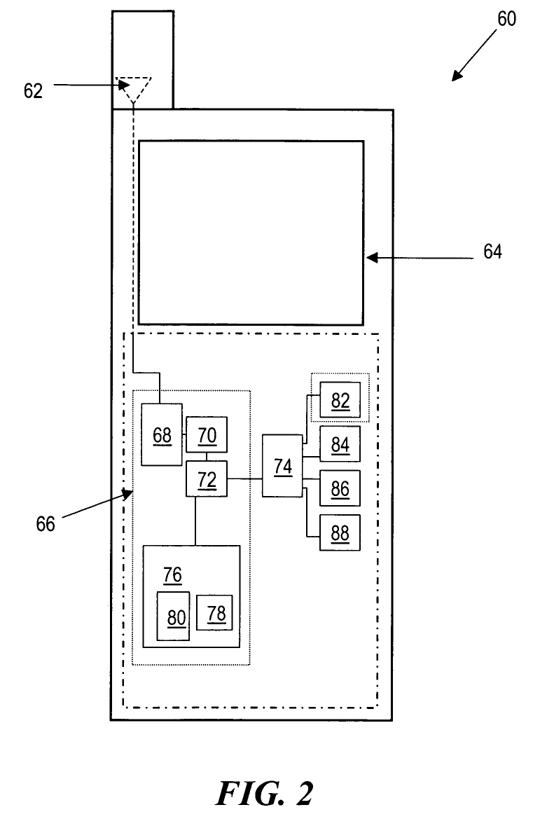

As described above, a Multi-Chip Package (MCP) that includes a modularized memory subsystem package may be located within a mobile device. FIG. 2 depicts one example of such a device. As mentioned above, FIG. 2 shows one embodiment of a mobile telephonic device 60 that incorporates teachings of the present disclosure. As shown, telephone 60 may include any of several different components. For example, telephone 60 may have an antenna 62 that works with a wireless wide area transceiver and/or a wireless local area transceiver. In practice, a wireless wide area transceiver may be part of a multi-device platform for communicating voice and/or data using RF technology across a large geographic area. The platform may be a GPRS, EDGE, or 3GSM platform, for example, and may include multiple integrated circuit (IC) devices or a single IC device.

Similarly, an included wireless local area transceiver may be capable of communicating using spread-spectrum radio waves in a 2.4 GHz range, 5 GHz range, or other suitable range. A wireless local area transceiver may also be part of a multi-device or single device platform and may facilitate communication of data and/or voice signals using low-power RF technology across a smaller geographic area.

For example, if the wireless local area transceiver includes a Bluetooth transceiver, the transceiver may enjoy a communication range having approximately a one hundred foot radius. If the wireless local area transceiver includes an 802.11 transceiver, such as an 802.11(b) or Wi-Fi transceiver, the transceiver may enjoy a communication range having approximately a one thousand foot radius. One skilled in the art will also recognize that the wireless local area transceiver and the wireless wide area transceiver may be separate or part of the same chipset. For example, telephone 60 may include a package having a chipset that combines Bluetooth, 802.11(b), and a GSM cellular technology, like GPRS.

As depicted, telephone 60 may also include a display device 64, which may be operable to present a graphical user interface (GUI) to a user. In the depicted embodiment, telephone 60 includes, among other things, several integrated circuits combined in packages, an antenna 62, and a liquid crystal display 64. Telephone 60 may include several different combinations of components. As depicted, telephone 60 includes a wide area wireless device platform 66, which may include, for example, a GPRS module. As shown, platform 66 includes a wide area wireless transceiver 68, front-end circuitry 70, dual core processor package 72, and a memory subsystem package 76. In practice, packages 72 and 76 may be combined into a multi-package package. Though package 72 is depicted as a dual core processor, in some implementations, package 72 may simply include a single ARM-based DSP.

In operation, front-end circuitry 70 may help ensure that the baseband electronics of package 72 will work well with transceiver 68. Processor package 72 may include, for example, a Digital Signal Processing (DSP) core as well as a core having RISC capabilities. In some embodiments, the components of telephone 60 may use dedicated hardware and DSP firmware to help provide advanced functionality.

In the depicted embodiment, package 72 is communicatively coupled to an application engine 74, which could be, for example, a Dragonball processor. In some embodiments, application engine 74 may be implemented on die with the baseband processor inside package 72. The memory system package 76 may include among other things a memory controller 78 and different forms of memory, represented collectively at 80. In practice and as shown, application engine 74 may also be coupled to package 76. In some embodiments, memory controller 78 may effectively allow essential memories to be moved off of package 72. For example, memories more typically packaged on chip with a core processor e.g. as temporary on-chip buffer may be moved off processor package 72 and placed on memory subsystem package 76.

In operation, application engine 74 may be communicatively coupled to several different components and may provide those components with additional processing capabilities. Example components may include a local area RF transceiver 82, which may be Bluetooth-enabled, Wi-Fi enabled, etc. Other components might be an imaging device 84, I/O module 86, and peripheral controller 88, which may manage keypad, LCD, CODEC, IrDA, and other functionality. Though shown as external to package 72, application engine 74 and interfaces for one or more of local area RF transceiver 82, imaging device 84, I/O module 86, and peripheral controller 88, may be included in package 72.

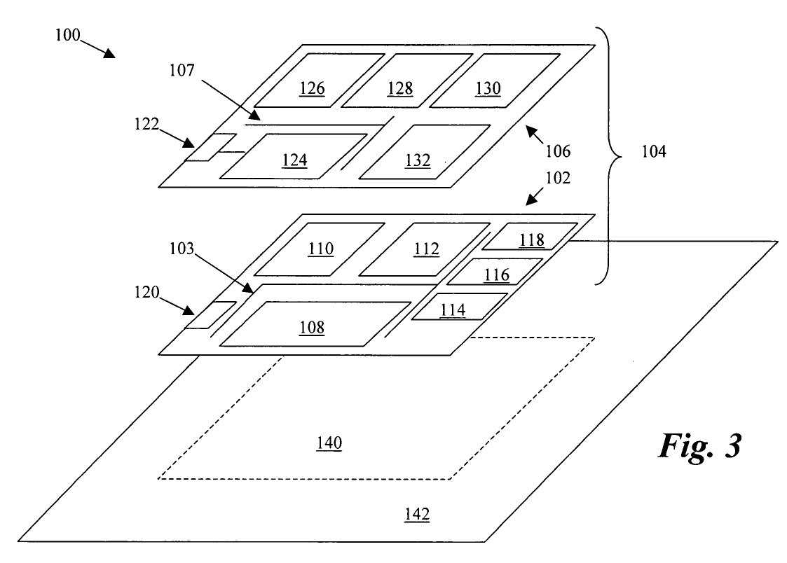

One skilled in the art will recognize that many of the above-described components could be combined or broken out into other devices, and the location of various components may be altered. One example packaging option for package 72 and memory subsystem package 76 is shown in FIG. 3. As mentioned above, FIG. 3 presents an exploded block diagram of a system 100 for a wireless-enabled device having a memory subsystem that incorporates teachings of the present disclosure. As shown, system 100 includes a baseband controller implemented in one package 102 of a multi-package package 104. As shown, MPP 104 has a package on package (PoP) configuration. Other configurations may be employed. In the depicted embodiment, the memory subsystem may be included in a different package 106. Depending upon design considerations, each of the packages may have a footprint of approximately 12 mm by 12 mm. In some designs, memory package 106 may have a footprint slightly smaller than that of package 102.

In practice, baseband controller package 102 may include an ARM 32-bit RISC processor 108 capable of running at several speeds. The ARM core processor 108 may drive several functions on controller package 102. For example, ARM core 108 may drive peripheral interfaces 114, 116, and 118, may drive power management features, multiple layers of the GSM protocol stack, and some data applications.

Other functions may be performed by a second core 110, which may be implemented as a DSP subsystem. The DSP core 110 may provide, for example, GSM-specific signal processing, echo and noise suppression, and some voice recognition capabilities. As shown, baseband controller package 102 also includes an application processor 112, which may help with multi-media and/or data intensive applications. Communication of information on package 102 may make use of an on-chip internal bus 103.

In some circumstances, interpackage communication may need to occur. ARM core 108 may need, for example, to make a read and/or write request of memory package 106. Such a memory command may be communicated via internal bus 103 to a bus interface 120. Bus interface 120 may effectively translate the communication so that it may be sent across an external bus capable of at least partially interconnecting package 102 and memory package 106.

The communication may be received at an interface 122 and communicated to a memory controller 124. As shown, memory controller 124 may be located on memory package 106 with memories 126, 128, 130, and 132. In practice, memories 126, 128, 130, and 132, may represent different types, and memory controller 124 may include an internal data bus that facilitates memory subsystem features such as local copying between controller ports. In an embodiment including an internal bus, some level of backwards compatibility may be provided for subsystem memory dies. In such an embodiment, memory controller 124 may effectively present each memory die with what appears to be a more conventional interface (e.g., NOR, NAND, DRAM etc.). Package 106 may also include another bus 107 having a width of 32 bits or more. For example, the data bus may be 64 bits wide, 128 bits wide, or wider.

Whatever the make up of memory package 106, MPP 104 may be secured in place 140. Place 140 may be formed into a housing component 142 of a cellular telephone or other mobile device. As shown, MPP 104 includes packages 102 and 106. Additional packages may be added.

It should be understood that the benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

What is claimed is:

1. A method of improved memory access comprising:
recognizing a need to access a memory;
initiating communication of a memory command via an internal bus located on a first chip;
receiving the memory command at a bus interface located on the first chip;
translating the memory command to facilitate communication via an external bus;
receiving a translated memory command at a memory controller via the external bus, the memory controller located on a different chip; and
accessing the memory from the memory controller via an internalized bus having a width of at least 32 bits to perform an operation indicated by the translated memory command, the internalized bus included within a multi-chip package.

2. The method of claim 1, wherein the external bus comprises a high frequency, low pin-count bus.

3. The method of claim 1, wherein the memory comprises a dynamic memory.

4. The method of claim 1, wherein the memory comprises DRAM.

5. The method of claim 1, wherein the memory is selected from a group consisting of SDRAM, DDRAM, NOR Flash, and DDR.

6. The method of claim 1, wherein the internalized bus has a width of 64 bits.

7. The method of claim 1, wherein a central processing unit located on the first chip initiates communication of the memory command.

8. The method of claim 1, further comprising:
recognizing a new need to access a different memory;
initiating communication of a new memory command via the internal bus located on the first chip;
receiving the new memory command at the bus interface located on the first chip;
translating the new memory command to facilitate communication via the external bus;
receiving the translated new memory command at the memory controller via the external bus; and
accessing the different memory from the memory controller.

9. The method of claim 8, further comprising creating a local copy in the different memory of information located in the memory without accessing the internal bus.

10. The method of claim 8, further comprising locating the memory controller, the memory, and the different memory in a top package of the multi-chip package.

11. The method of claim 1, further comprising operating the external bus at 200 MHz.

12. The method of claim 1, further comprising applying low-voltage differential signaling across the external bus.

13. The method of claim 10, further comprising securing the multi-chip package within an interior cavity of a mobile device.

14. The method of claim 13, wherein the interior cavity is at least partially formed by a housing component of a wireless telephonic device.

15. A method of improving memory operation in a mobile device, comprising:
forming a memory subsystem module that comprises a memory controller and a dynamic memory;
collapsing the pin count necessary to interconnect the memory controller and the dynamic memory into a collection of internalized interconnects included within a multi-chip package;
using a low pin count external bus to form at least a portion of a communication path interconnecting the memory controller of the memory subsystem with a central processing unit located on a different chip; and
forming the different chip and the memory subsystem for location within the mobile device.

16. The method of claim 15, further comprising defining a mechanical interface for the memory subsystem that supports locating a package containing the memory subsystem as a top package in a multi-chip package.

17. The method of claim 15, further comprising booting the mobile device using information located in the memory subsystem.

18. A mobile device memory system, comprising:
a central processing unit (CPU) for a mobile device residing on a first chip;
a modular memory system residing off the first chip and in a multi-chip package, the modular memory system comprising a memory controller interconnected with at least one type of memory via interfaces internalized within a package; and
a high frequency, low pin-count external bus forming at least a portion of a link communicatively coupling the memory controller and the CPU.

19. The system of claim 18, further comprising a bus interface residing on the first chip, the bus interface being communicatively coupled to both the external bus and an internal CPU bus also located on the first chip.

20. The system of claim 19, wherein the at least one type of memory is selected from a group consisting of a NOR Flash type, an SDRAM type, an SRAM type, and a DDR type.

21. The system of claim 20, further comprising a 64 bit wide data bus internalized within the multi-chip package and interconnecting the memory controller with the at least one type of memory.

22. The system of claim 21, further comprising an application processor communicatively coupled to the internal CPU bus.

23. The system of claim 22, further comprising a housing component of a mobile device, the housing component at least partially forming an internal cavity housing the first chip and the multi-chip package.

24. The system of claim 18, wherein the first chip does not contain NOR Flash type memory, SDRAM type memory, SRAM type memory, or DDR type memory.

25. A system for improved memory performance in a mobile device, comprising:
a multi-chip package having a package on package configuration;
a first package of the multi-chip package comprising a baseband controller, the baseband controller having at least one core processor,
a second package of the multi-chip package comprising a memory subsystem, the memory subsystem having at least one type of memory and a memory controller; and
an interconnection mechanism forming at least a portion of a communication link interconnecting the at least one core processor and the memory controller.

26. The system of claim 25, further comprising a second core processor, wherein the second core processor comprises a Digital Signal Processing core processor.

27. The system of claim 25, wherein the interconnection mechanism comprises a low pin-count external bus.

28. The system of claim 25, wherein the first package resides at a layer of the multi-chip package that is lower than a second package layer.

29. The system of claim 25, further comprising a bus interconnecting the at least one type of memory and the memory controller, wherein the bus has a width of at least 64 bits.

30. The system of claim 25, further comprising a cellular telephone, wherein the cellular telephone comprises a display and the multi-chip package.

31. The system of claim 25, further comprising a cellular telephone, wherein the cellular telephone comprises a display, a keypad, an MP3 player, a local area wireless transceiver, a wide area wireless transceiver, and the multi-chip package.
